(19) United States
(12) Patent Application Publication
(10) Pub. No.: US 2014/0125328 A1
(43) Pub. Date: May 8, 2014

(54) MAGNETIC DETECTION DEVICE

(71) Applicant: MITSUBISHI ELECTRIC CORPORATION, Tokyo (JP)

(72) Inventors: Yoshinori TATENUMA, Chiyoda-ku (JP); Yuji KAWANO, Chiyoda-ku (JP)

(73) Assignee: MITSUBISHI ELECTRIC CORPORATION, Tokyo (JP)

(21) Appl. No.: 13/868,277

(22) Filed: Apr. 23, 2013

(30) Foreign Application Priority Data
Nov. 7, 2012 (JP) 2012-244993

(51) Int. Cl. G01B 7/30

(52) U.S. Cl. CPC G01B 7/30
USPC 324/207.21

(57) ABSTRACT

For the purpose of obtaining a magnetic detection device which accurately detects rotational angle information of an object to be detected in a simpler configuration, the magnetic detection device includes a magnetoresistive element composed of: a magnetization fixed layer, a magnetization free layer, and a nonmagnetic intermediate layer sandwiched between the magnetization fixed layer and the magnetization free layer. A potential difference between both ends of the magnetoresistive element is fixed voltage, and a change in current value of the magnetoresistive element with respect to a change in magnetic field is detected.

### BACKGROUND OF THE INVENTION

1. Field of the Invention

The present invention relates to a magnetic detection device which uses a magnetoresistive element and detects a rotational angle of an object to be detected by a change in magnetic field.

2. Description of the Related Art

There exists a system in which a Wheatstone bridge circuit is constituted by forming electrodes on both ends of each magnetoresistive element serving as a magneto-electric transducer, a constant voltage power supply is connected between two facing electrodes of the bridge circuit, a change in resistance value of the magnetoresistive element is converted into a change in voltage to detect a change in magnetic field acting on the magnetoresistive element (Patent Document 1).

FIG. 10 is a circuit configuration diagram showing such a Wheatstone bridge circuit.

In the drawing, each of magnetoresistive elements 101, 102, 103, and 104 constituting the bridge circuit has, as shown in FIG. 11, a laminated body composed of: a magnetization fixed layer 111 whose magnetization direction is fixed with respect to an external magnetic field; a magnetization free layer 113 whose magnetization direction changes in response to the external magnetic field; and a nonmagnetic intermediate layer 112 which is sandwiched between the magnetization fixed layer 111 and the magnetization free layer 113. The magnetization of the magnetization free layer 113 freely rotates within the film surface of the laminated body in response to the external magnetic field. In this case, description will be made on an example of a tunnel magnetoresistive element (hereinafter, referred to as a “TMR element”) in which the nonmagnetic intermediate layer 112 is an insulating body.

It is known that the electrical properties of the TMR element are represented in the form of conductance G (Non-Patent Document 1). When a relative angle with the magnetization direction of the magnetization free layer 113 is θ with respect to the magnetization direction of the magnetization fixed layer 111, the conductance G is expressed as follows: and in this case, the magnetization direction of the magnetization free layer 113 matches with the direction of the external magnetic field, that is, a rotational angle θ of the magnetic field.

G=G0+G1 cos θ (equation 1)

When this is expressed by a resistance value, it becomes the reciprocal of equation 1.

R=1/(G0+G1 cos θ) (equation 2)

Incidentally, in FIG. 10, the magnetization direction of the magnetization fixed layer 111 for each of the TMR elements 101, 102, 103, and 104 is shown by the direction of arrow 105, 106, 107, and 108, respectively. Furthermore, arrow 109 of a central portion of the Wheatstone bridge circuit shows the direction of the external magnetic field.

Now, focused attention is the TMR element 101 and the TMR element 102. FIG. 12 shows how the conductance G of the TMR element 101 and the TMR element 102 changes if the direction of the magnetic field 109 rotates 360°. When the direction of the magnetic field is the same as the direction of magnetization of the magnetization fixed layer (θ=0°), the conductance G is the largest as shown in equation 1. Furthermore, when the direction of the magnetic field is opposite to the direction of the magnetization of the magnetization fixed layer (θ=180°), the conductance G is the smallest; and values of the conductance G are inverted 180° from each other because the direction of the magnetization of the magnetization fixed layer of the TMR element 102 differs 180° from that of the TMR element 101.

On the other hand, in1 that is electrically neutral point potential of the TMR element 101 and the TMR element 102 is calculated using equation 2; and the neutral point potential in1 becomes the following equation 3.

in1=(G0+G1 cos θ)/2G0 (equation 3)

As shown in this equation 3, cos θ appears on the numerator side; and the denominator side is a constant; and therefore, it becomes so-called a cosine waveform of a trigonometric function.

In this case, if the TMR element 102 is a fixed resistance value R0 regardless of the magnetic field direction, the neutral point potential in1 becomes the following using equation 2.

in1=R0(G0+G1 cos θ)/[R0(G0+G cos θ)+1] (equation 4)

As expressed in this equation 4, cos θ appears on both the numerator side and the denominator side; and therefore, it becomes a waveform which is different from so-called the cosine waveform or sine waveform of the trigonometric function. If on the assumption that the angle of the magnetic field direction is calculated on the premise of outputting an ideal cosine or sine waveform, the waveform of the equation 4 deviates from the ideal cosine or sine waveform and therefore such a way is undesirable.

Therefore, it is suggested to configure the bridge circuit of the magnetoresistive elements as shown in FIG. 10.

Next, description will be made, as an example, of the case where a magnetization rotor 121 as shown in FIGS. 13A and 13B is used to apply a magnetic field from the outside to the TMR element. In this case, the axial center of the magnetization rotor 121 is simply shown by 122; and a magnetic field direction in the vicinity of the surface of the magnetization rotor 121 is simply shown by 123. The TMR elements 101 and 102 are arranged close to the magnetization rotor 121; and the direction of the magnetization fixed layer of the TMR element 102 is shown by arrow 124. The magnetic field direction 123 in the vicinity of the surface of the magnetization rotor 121 is approximately the same as the magnetic field direction in the vicinity of the TMR elements 101 and 102.

When the magnetized magnetization rotor 121 rotates under such a configuration, the direction of the magnetic field to be applied to the TMR elements 101 and 102 changes. The TMR elements 101 and 102 constitute the bridge circuit as shown in FIG. 10; and when the magnetization rotor 121 rotates, the magnetic field direction rotates 360°×2=720°. Therefore, rotational angle information of the magnetization rotor 121 can be obtained from the output of the neutral point potential in1 of the bridge circuit of the TMR element 101 and the TMR element 102. At this time, for example, the TMR element 101 and the TMR element 102 need to be arranged at positions close to each other. However, as shown in FIG. 13A, the arrangement of the TMR element 101 and the TMR element 102 at just the same point is difficult. In fact, these elements are arranged with a certain level of gap; and therefore, angle misalignment occurs. This angle misalignment could be factors that degrade accuracy in detecting the rotation.

Furthermore, as shown in FIG. 13B, if the TMR elements 101 and 102 are arranged at positions separated from each other, the influence of the angle misalignment can be reduced. However, the arrangement positions depend on the size of the magnetization rotor 121 and the arrangement positions of the TMR element 101 and the TMR element 102 need to be determined for each size of the magnetization rotor 121; and therefore, a problem exists in that it lacks versatility.
[Patent Document 1] Japanese Examined Patent Publication No. 3017061
[Non-Patent Document 1] “Angular dependence of the tunnel magnetoresistance in transition-metal-based junctions”: Physical Review B, Vol. 64, 064427 (2001) (equation (2) and column of V. CONCLUSION)

### BRIEF SUMMARY OF THE INVENTION

The present invention has been made to solve the above described problems, and an object of the present invention is to provide a magnetic detection device capable of obtaining more accurate rotational angle information by using one magnetoresistive element.

A magnetic detection device according to the present invention includes a magnetoresistive element composed of: a magnetization fixed layer whose magnetization direction is fixed with respect to an external magnetic field; a magnetization free layer whose magnetization direction rotates in response to the external magnetic field; and a nonmagnetic intermediate layer which is sandwiched between the magnetization fixed layer and the magnetization free layer. In the magnetic detection device, a potential difference between both ends of the magnetoresistive element is fixed voltage, and a change in current value of the magnetoresistive element with respect to a change in magnetic field is detected.

According to the present invention, effects can be exhibited in that a Wheatstone bridge circuit configuration is not required and accurate rotational angle information of an object to be detected can be obtained by a simpler configuration.

### BRIEF DESCRIPTION OF THE SEVERAL VIEWS OF THE DRAWINGS

FIG. 1 is a circuit configuration diagram of a magnetic detection device according to Embodiment 1 of the present invention;

FIG. 2 is a general outline view showing a relevant part configuration in FIG. 1;

FIG. 3 is a waveform view for explaining the operation of the magnetic detection device according to Embodiment 1 of the present invention;

FIG. 4 is a circuit configuration diagram of a magnetic detection device according to Embodiment 2 of the present invention;

FIG. 5 is a waveform view for explaining the operation of the magnetic detection device according to Embodiment 2 of the present invention;

FIG. 6 is a circuit configuration diagram of a magnetic detection device according to Embodiment 3 of the present invention;

FIG. 7 is a waveform view for explaining the operation of the magnetic detection device according to Embodiment 3 of the present invention;

FIG. 8 is a circuit configuration diagram of a magnetic detection device according to Embodiment 4 of the present invention;

FIG. 9 is a waveform view for explaining the operation of the magnetic detection device according to Embodiment 4 of the present invention;

FIG. 10 is a circuit configuration diagram showing a known Wheatstone bridge circuit;

FIG. 11 is a perspective view showing the structure of the known magnetoresistive element;

FIG. 12 is a waveform view for explaining operating characteristics of the known magnetoresistive element; and

FIGS. 13A and 13B are general outline views each showing other configuration of the known magnetic detection device.

### DETAILED DESCRIPTION OF THE INVENTION

### Embodiment 1

Hereinafter, the present invention will be described with reference to drawings that are embodiments.

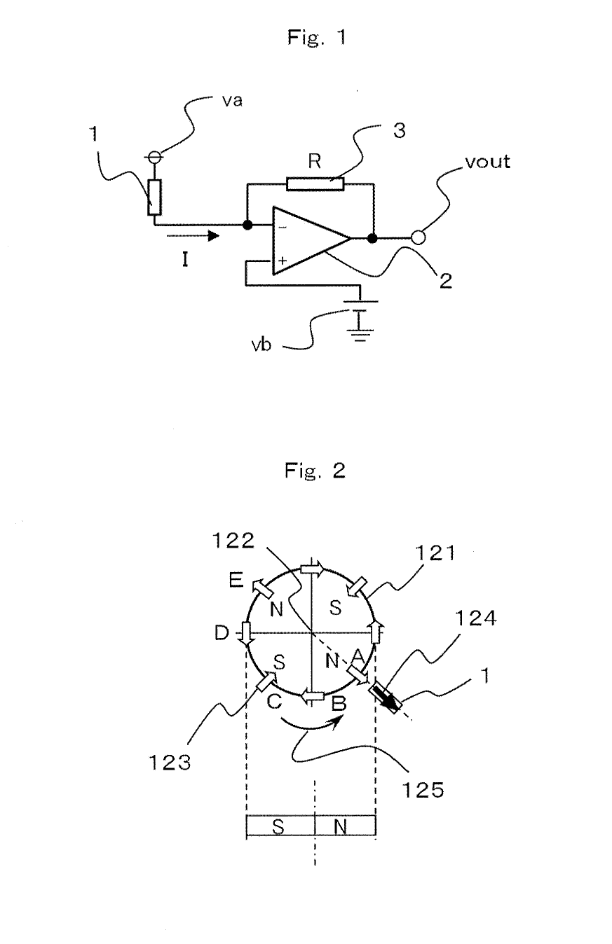

FIG. 1 is a circuit configuration diagram showing a magnetic detection device according to Embodiment 1 of the present invention.

In FIG. 1, a TMR element 1 is composed by laminating a magnetization fixed layer 111, a nonmagnetic intermediate layer 112, and a magnetization free layer 113, these layers being like those shown in FIG. 11. A predetermined voltage va is supplied to an input end of the TMR element 1; and an output end thereof is connected to one input end of an operational amplifier 2 serving as an amplifying unit. A power supply voltage vb that is reference potential is supplied to the other input end of the operational amplifier 2 and output vout is generated at an output end thereof. A fixed resistor 3 that determines the magnification of amplification is connected to an output end and one input end of the operational amplifier 2; and these elements constitute the magnetic detection device.

Incidentally, current flowing through the TMR element 1 is I and a resistance value of the fixed resistor 3 is R.

FIG. 2 is a general outline view showing the positional relationship between a magnetization rotor 121 and the TMR element 1; a magnetic field direction in the vicinity of the surface of the magnetization rotor 121 is simply shown by arrow 123; and the direction of magnetization of the magnetization fixed layer of the TMR element 1 is simply shown by arrow 124. In this case, the magnetic field direction 123 in the vicinity of the surface of the magnetization rotor 121 is approximately the same as the magnetic field direction in the vicinity of the TMR element 1. The magnetization rotor 121 rotates centering on the axial center 122 and its rotational direction is shown by arrow 125.

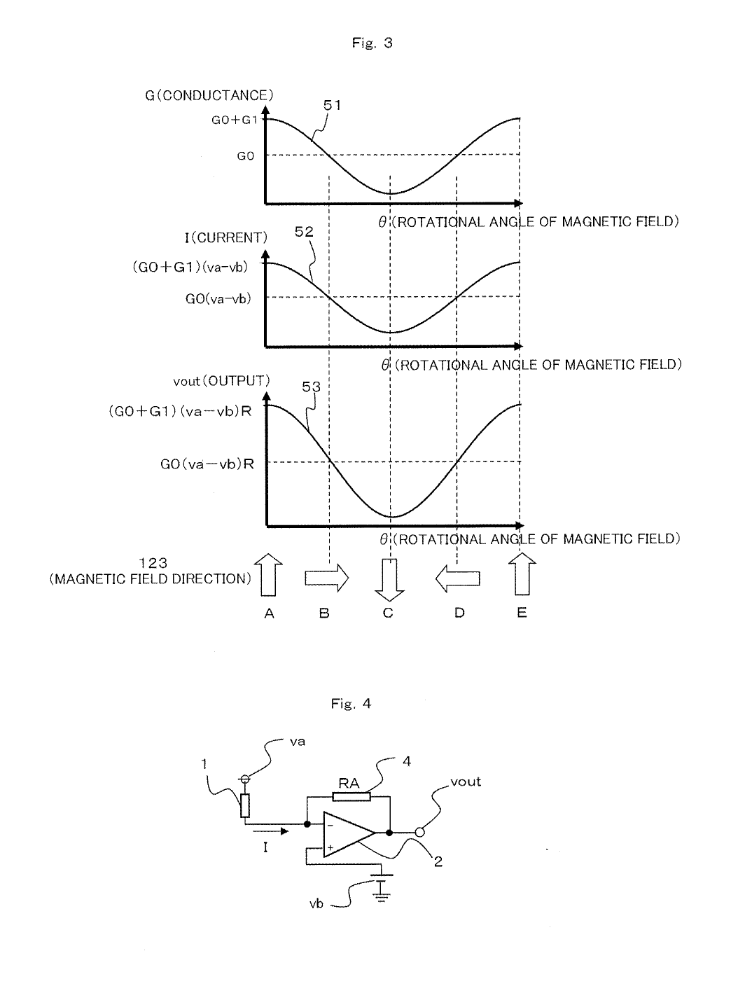

When the magnetization rotor 121 rotates under such a configuration, and if the magnetization rotor 121 faces the TMR element 1 at a position A in FIG. 2, the direction of magnetization 124 of the magnetization fixed layer of the TMR element 1 matches with the direction of the magnetic field 123; and therefore, this shows a state of θ=0 in equation 1. Therefore, conductance G at the position of 0° is G0+G1 as shown in FIG. 3.

Furthermore, the current I flowing through the TMR element 1 is (G0+G1) (va−vb) because a voltage across both ends of the TMR element 1 is fixed voltage (va−vb).

Therefore, the output voltage vout of the operational amplifier 2 is the product of the fixed resistor 3 and the current flowing through the TMR element 1; and therefore, the output voltage vout is (G0+G1)(va−vb)R.

Next, if the magnetization rotor 121 rotates by 45° in the direction of the arrow 125, that is, if the magnetization rotor 121 faces the TMR element 1 at a position B, the direction of the magnetic field is in a state of 0=90° in the equation 1, which is different from that of the position A. In this case, the conductance G is G0; the current I of the TMR element 1 is G0(va−vb); and the output vout is G0(va−vb)R.

Thus, the output vout forms a cosine waveform as shown in FIG. 3 with respect to rotational positions A, B, C, D, and E of the magnetization rotor 121.

Incidentally, in FIG. 3, a conductance waveform of the TMR element 1 is shown by 51; a current waveform of the TMR element 1 is shown by 52; and an output voltage vout waveform of the operational amplifier 2 is shown by 53.

As described above, the output voltage vout of the operational amplifier 2 is output in a cosine waveform in connection with the rotation of the magnetization rotor 121; and therefore, accurate rotational angle information of the magnetization rotor 121 can be obtained.

At this time, the predetermined voltage va can also be 0[V] (ground); and in this case, the number of power supplies can be reduced. Furthermore, the magnetization rotor 121 may have either a plurality of pairs of N-poles and S-poles shown in FIG. 2 or a pair of N-pole and S-pole. Further, the position of the TMR element 1 is disposed outside the circumference of the magnetization rotor 121 in FIG. 2. However, the TMR element 1 may be disposed on the axial center 122 of the magnetization rotor 121, and the magnetization rotor 121 may use any figure (cuboid, sphere, or the like) if the magnetic field direction to be applied to the TMR element 1 rotates.

Thus, the circuit which converts the current flowing through the TMR element 1 into voltage and outputs is provided; and accordingly, it becomes possible to obtain accurate rotational angle information of an object to be detected by a simpler configuration without providing the configuration in which the TMR elements 1 are connected to a Wheatstone bridge circuit.

### Embodiment 2

FIG. 4 is a circuit configuration diagram showing a magnetic detection device according to Embodiment 2 of the present invention.

In the drawing, a fixed resistor 4 is connected to an output end and one input end of an operational amplifier 2 serving as an amplifying unit and determines the magnification of amplification. The fixed resistor 4 is set to a resistance value RA, and its temperature coefficient is set to the same as a temperature coefficient of resistance of a TMR element 1. The other configuration is the same as that of Embodiment 1 in FIG. 1.

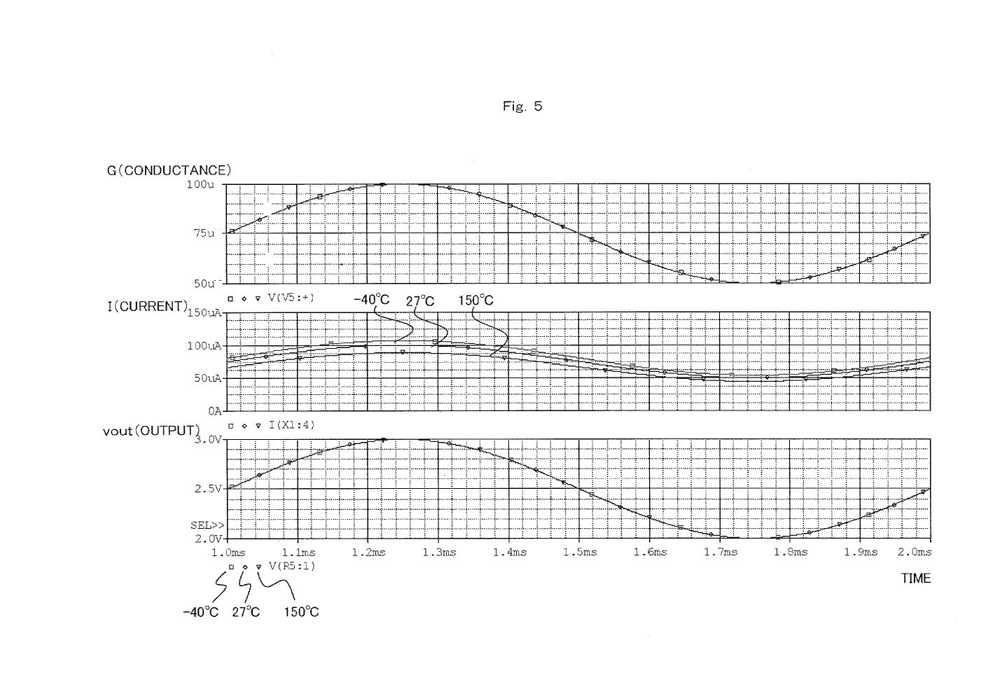

FIG. 5 is a simulation view showing operation waveforms at the time when temperature changes at −40° C., 27° C., and 150° C., respectively in Embodiment 2, where va=0 [V]; vb=1 [V]; RA=20 k [Ω]; a conductance value of the TMR element 1=0.000075+0.000025×cos θ [G]; a temperature coefficient TC1 of the TMR element 1 and the fixed resistor 4=0.001; and e is converted into time. As shown in the drawing, a difference appears in the waveform of the current I at each temperature; however, the output vout is shown in overlapped waveforms. Thus, it becomes possible to cancel out a difference in amplitude due to temperature by matching the temperature coefficient of the TMR element 1 with that of the fixed resistor 4.

Incidentally, as for the temperature coefficient of the fixed resistor 4, for example, it is permissible if the fixed resistor 4 is made up of a TMR element having the same temperature coefficient of resistance as that of the TMR element 1 and a magnetic field direction does not change.

Furthermore, if it is difficult to prepare the fixed resistor having a temperature coefficient of resistance, which is equivalent to that of the TMR element 1, the following method can be used.

The fixed resistor 4 uses two types of fixed resistances RA and RB each having a different temperature coefficient and these resistances are connected in series. If the temperature coefficient of the resistance of the TMR element 1 is TCtmr, the temperature coefficient of the resistance RA is TCA, and the temperature coefficient of the resistance RB is TCB, the resistance RA and the resistance RB in which the following equation is established are prepared.

TCA<TCtmr<TCB (equation 10)

When the resistance RA and the resistance RB are formulated, this results in the following.

RA=RA0[1+TCA(t−t0)] (equation 11)

RB=RB0[1+TCB(t−t0)] (equation 12)

where, RA0 and RB0 show resistance values of reference temperature, t0 shows reference temperature, and t shows temperature. The resistance RA and the resistance RB are connected in series; and therefore, combined resistance is the following by equation 11 and equation 12:

RA+RB=(RA0+RB0)[1+(TCA×RA0+TCB×RB0)(t−t0)/(RA0+RB0)] (equation 13)

A temperature coefficient of the combined resistance of the resistance RA and the resistance RB indicates a part of (TCA×RA0+TCB×RB0)/(RA0+RB0) in equation 13; and when each resistance value of the resistance RA and the resistance RB is adjusted, the same temperature coefficient of the resistance as that of the TMR element 1 can be obtained.

Thus, the circuit which converts current flowing through the TMR element 1 into voltage and outputs is prepared and the fixed resistor 4 which determines the magnification of the operational amplifier that converts voltage into current is the fixed resistance having the same temperature coefficient of the resistance as that of the TMR element 1; and accordingly, effects can be exhibited in that a difference in amplitude of the voltage due to temperature can be cancelled out and rotational angle information of a body to be detected can be accurately obtained without depending on temperature.

### Embodiment 3

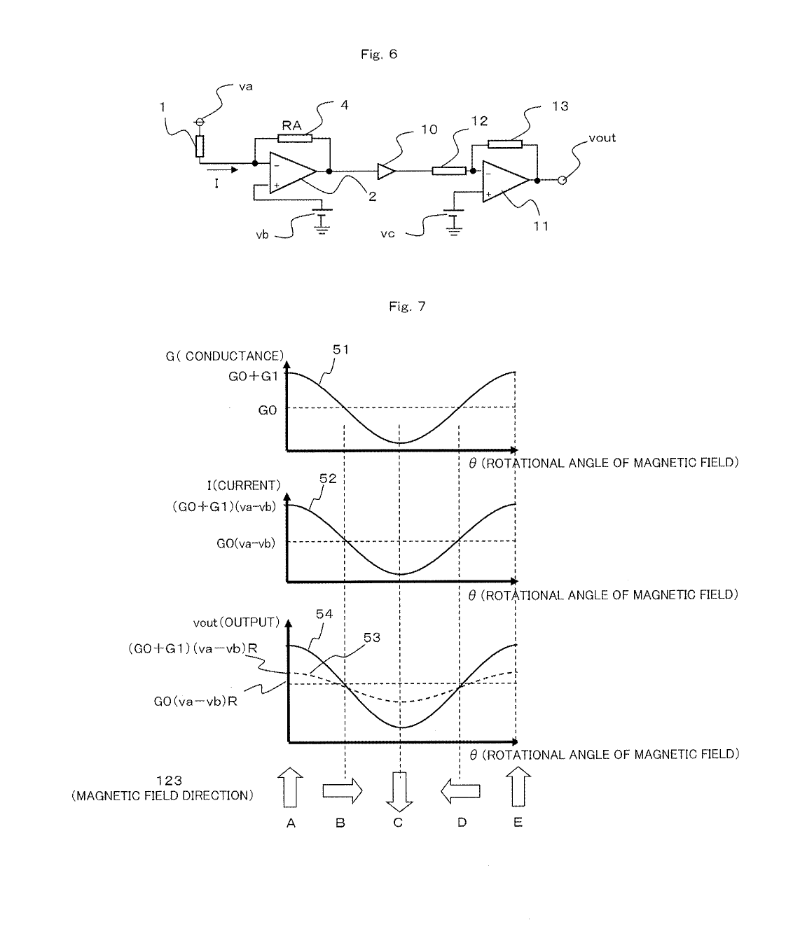

FIG. 6 is a circuit configuration diagram showing a magnetic detection device according to Embodiment 3 of the present invention; and this is a circuit configuration in which a second amplifying unit is connected to the magnetic detection device in FIG. 4. In the drawing, a buffer 10, an operational amplifier 11 serving as the second amplifying unit, fixed resistors 12 and 13 which determine the magnification of the operational amplifier 11, and reference potential vc connected to the other input end of the operational amplifier 11 are provided at a subsequent stage of an operational amplifier 2 serving as a first amplifying unit.

By such a configuration, it becomes possible to adjust the output amplitude of the operational amplifier 11 by the fixed resistor 12 and the fixed resistor 13, and an offset component of the output amplitude of the operational amplifier 11 can be adjusted by the reference potential vc.

That is, as shown by a waveform 54 in FIG. 7, an output vout of the operational amplifier 11 can be larger than an input waveform 53 of the buffer 10.

Incidentally, in the drawing, reference numeral 51 shows conductance of the TMR element 1 and 52 shows a change in current of the TMR element 1.

Thus, the circuit which converts current flowing through a TMR element 1 into voltage and outputs is prepared and the operational amplifier 11 serving as the second amplifying unit is connected at the subsequent stage; and accordingly, an effect can be exhibited in that the offset component of the output and the amplitude component of the output can be adjusted and therefore a desired output can be obtained.

### Embodiment 4

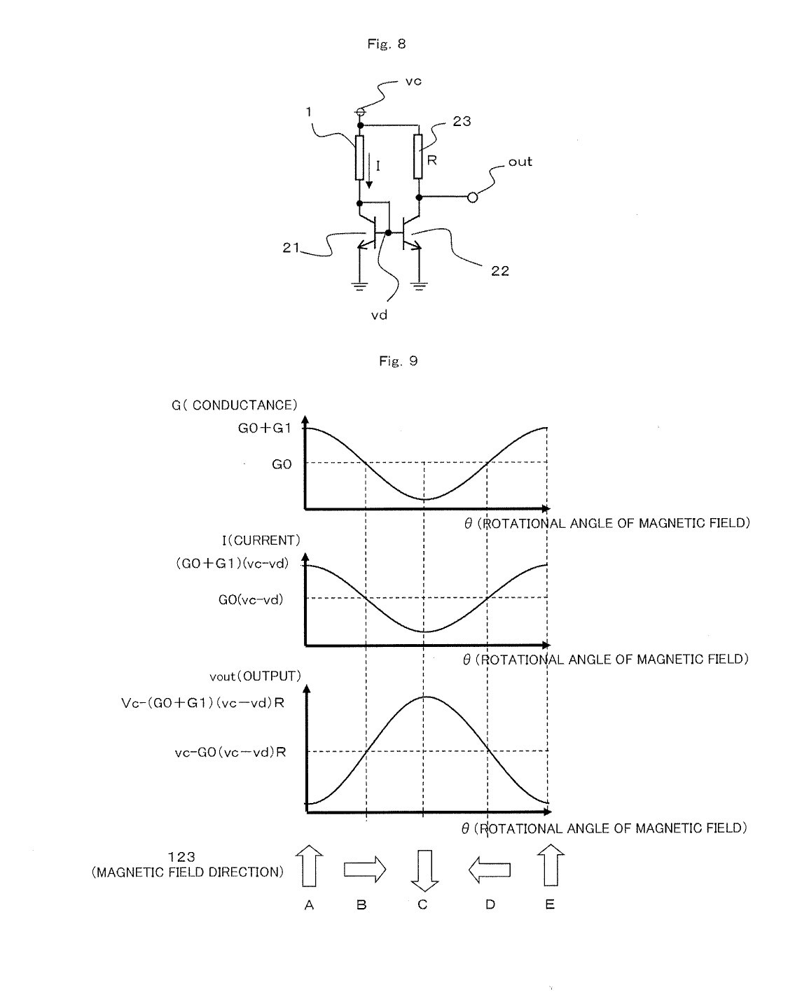

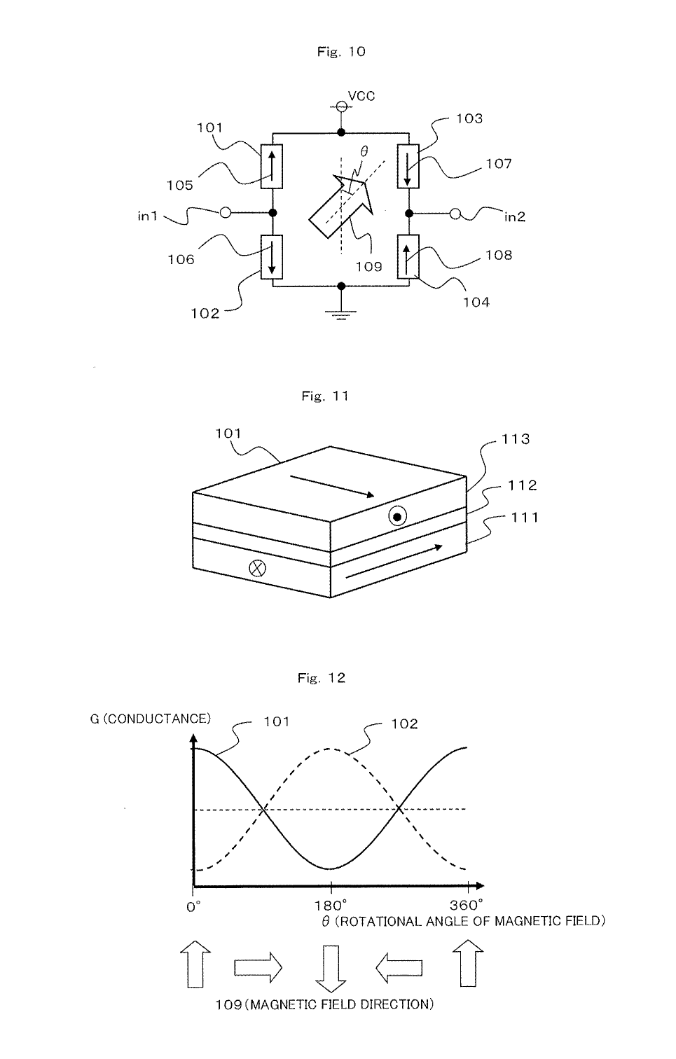

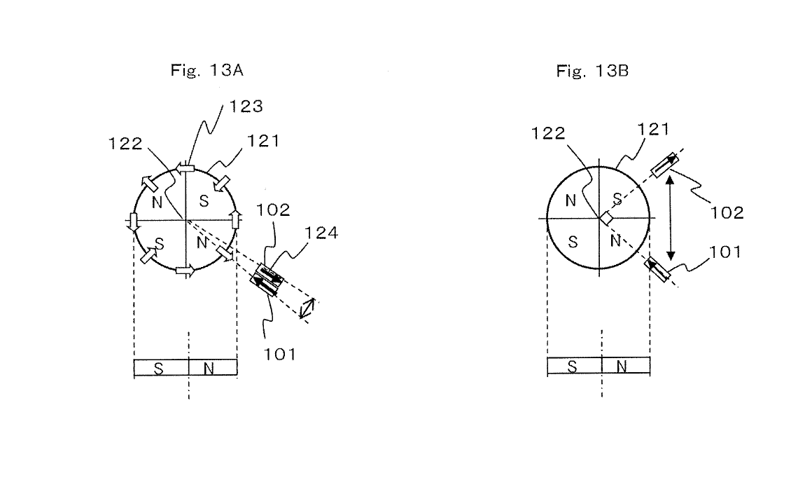

FIG. 8 is a circuit configuration diagram showing a magnetic detection device according to Embodiment 4 of the present invention. In the drawing, a TMR element 1 is connected to the current supply side of a current mirror circuit composed of a power supply vc, a transistor 21, and a transistor 22; and a fixed resistor 23 is connected to the output side of the current mirror circuit. In this case, the transistor 21 and the transistor 22 have the same transistor characteristics; and forward potential between a base and an emitter is Vd. Furthermore, current flowing through the TMR element 1 is I and a resistance value of the fixed resistor 23 is R.

Incidentally, the positional relationship between the TMR element 1 and a magnetization rotor 121 is set similarly to that of FIG. 2.

When the magnetization rotor 121 rotates under such a configuration, and if the magnetization rotor 121 faces the TMR element 1 at a position A in FIG. 2, the direction of magnetization 124 of a magnetization fixed layer of the TMR element 1 matches with the direction of a magnetic field 123; and therefore, this shows a state of θ=0 in equation 1. Therefore, conductance G at the position of 0° is G0+G1 as shown in FIG. 9.

Furthermore, forward potential (fixed voltage) vd of the transistor 21 and fixed voltage vc are applied to both ends of the TMR element 1; and therefore, the current I flowing through the TMR element 1 is (G0+G1)(vc−vd). Further, the current mirror circuit is formed; and therefore, the current of (G0+G1)(vc−vd) also flows through the fixed resistor 23 on the output side and output voltage vout at an output end is vc−R(G0+G1)(vc−vd).

Similarly, when the magnetization rotor 121 rotates in the direction of arrow 125, the output voltage vout changes in turn as shown in FIG. 9; and this shows a cosine waveform.

As described above, the output voltage vout of the current mirror circuit outputs the cosine waveform in connection with the rotation of the magnetization rotor 121; and therefore, accurate rotational angle information of the magnetization rotor 121 can be obtained.

Incidentally, in the above embodiments, the tunnel magnetoresistive element is described as the magnetoresistive element; however, those using a giant magnetoresistive element can also be similarly implemented.

Furthermore, in the present invention, embodiments can be appropriately changed or omitted within the scope of the present invention.

The present invention can be applied to a steering control device which is mounted on an automobile or the like and detects the rotational angle of steering.

### DESCRIPTION OF REFERENCE NUMERALS

1: Magnetoresistive element (TMR element)
2: Operational amplifier (first amplifying unit)
3, 4: Fixed resistor
10: Buffer
11: Operational amplifier (amplifying unit)
12, 13, 23: Fixed resistor
101 to 104: Magnetoresistive element
111: Magnetization fixed layer
112: Nonmagnetic intermediate layer
113: Magnetization free layer
121: Magnetization rotor

What is claimed is:

1. A magnetic detection device which detects a rotational angle of an object to be detected by a change in magnetic field, said magnetic detection device comprising a magnetoresistive element composed of: a magnetization fixed layer which is magnetized in one direction, and whose magnetization direction is fixed with respect to an external magnetic field; a magnetization free layer whose magnetization direction rotates in response to the external magnetic field; and a nonmagnetic intermediate layer which is sandwiched between said magnetization fixed layer and said magnetization free layer,
wherein a potential difference between both ends of said magnetoresistive element is fixed voltage, and
a change in current value of said magnetoresistive element with respect to a change in magnetic field is detected.

2. The magnetic detection device according to claim 1,
further comprising an amplifying unit which is used as a unit that detects the change in current value.

3. The magnetic detection device according to claim 2,
wherein the magnification of amplification of said amplifying unit is capable of adjusting so that the output of said amplifying unit does not change with respect to a change in temperature of said magnetoresistive element.

4. The magnetic detection device according to claim 3,
further comprising a fixed resistor which is a unit that determines the magnification of amplification of said amplifying unit,
a temperature coefficient of resistance of said fixed resistor being the same as a temperature coefficient of resistance of said magnetoresistive element.

5. The magnetic detection device according to claim 2,
further comprising a second amplifying unit which is provided at a subsequent stage of said amplifying unit and adjusts to a desired magnification.

6. The magnetic detection device according to claim 1,
further comprising a current mirror circuit which is used as a unit that detects the change in current value.

7. The magnetic detection device according to claim 1,
wherein said magnetoresistive element is a tunnel magnetoresistive element or a giant magnetoresistive element.
